(19) United States
(12) Patent Application Publication
(10) Pub. No.: US 2016/0171526 A1
(43) Pub. Date: Jun. 16, 2016

(54) IDENTIFYING AND CREDITING REBATES TO USERS OF AN AFFILIATE MARKETING REBATE SYSTEM

(71) Applicant: COUPONCABIN LLC, Whiting, IN (US)

(72) Inventor: Scott E. Kluth, Streamwood, IL (US)

(21) Appl. No.: 14/965,542

(22) Filed: Dec. 10, 2015

Related U.S. Application Data
(60) Provisional application No. 62/090,210, filed on Dec. 10, 2014.

(51) Int. Cl. G06Q 30/02

(52) U.S. Cl. CPC G06Q 30/0236; G06Q 30/0234

(57) ABSTRACT

The present disclosure is directed to systems and methods for crediting users with rebate commissions in response to the users completing purchase transactions via retailer websites. According to embodiments, the systems and methods may determine that, after a user has completed a purchase transactions, the user is not enrolled in a rebate service. The systems and methods may generate a notification of the same and provide the notification to a client device for access by the user, where the client device may enable the user to register for the rebate service. In response to the user registering for the rebate service, the systems and methods may update an account of the user to reflect the rebate commission.

### CROSS-REFERENCE TO RELATED APPLICATIONS

This application claims the benefit of U.S. Provisional Application No. 62/090,210, filed Dec. 10, 2014, which is incorporated by reference herein in its entirety.

### TECHNICAL FIELD

The present disclosure generally relates to a system and method for identifying online purchase transactions that are eligible for a discount or rebate on the purchase price when a customer is not currently enrolled in a corresponding discount or rebate program, and facilitating enrollment and discount or rebate crediting for the enrolled customer.

### BACKGROUND

Online retailers have employed various methods to draw customers to their websites, including methods that have their origin in traditional, “brick and mortar” sales transactions. One method is the use of discounts in the form of coupons. Traditional coupons are offered to a potential customer through printed circulars, newspaper supplements, magazine advertisements, etc., and usually offer some sort of discount off of the regular sale price of an item. Bar codes on the printed coupons allow the retailer and manufacturer to track various information about the sale including the origin of the printed coupon (e.g., the newspaper, magazine, or other physical source of the coupon). By tracking information about the source of the coupon, the retailer or manufacturer may also provide a commission from the sale of the item to the coupon publisher as motivation to publish future coupons.

Coupons are also used in online sales transactions. Sales commissions may be earned by entities that publish, aggregate, and maintain online coupon codes or discount links through affiliate marketing. In an affiliate marketing relationship, a retailer or other online business rewards one or more third parties or “affiliates” for a sale transaction that originates by the affiliate's marketing efforts. Affiliate marketing typically includes four entities: a retailer, an affiliate network, a publisher or affiliate, and a customer. Affiliate networks partner with publishers who provide online coupon codes or discount links to help draw more customers to the retailers. In essence, a retailer will pay a sales commission to one or more of the affiliate network and the affiliate for directing potential customers to the retailer's website to complete a sale transaction.

The affiliate network and affiliate are able to realize a sales commission if the retailer is able to directly credit a sale to those entities. The retailer, affiliate network, and affiliate are able to track the origin of the sale by using web browser cookies or other means. Typically, a user visits an affiliate's website by entering the affiliate's URL directly into the user's browser, by a search engine, by following a link in an email, etc. The user may find a coupon code or discount link for a retailer and then select or click that link or code that includes a request URL. Selecting the coupon or link by the user sends the user's browser to the affiliate network's server along with an identifying code contained in the request URL indicating that the affiliate was the referral source. The affiliate network's server/redirector sets a cookie on the user's computer that identifies the affiliate and the affiliate network to the retailer. The user's browser then redirects to the retailer's website. The user shops at the retailer's website and as part of the checkout process, where the customer may enter the coupon code in an appropriate field. Upon completion, the sale is logged to a server at the affiliate network and the affiliate network reports the completed transaction back to its source: the affiliate. The affiliate may earn a percentage commission on the sale according to terms agreed to with the retailer because the retailer was able to identify the affiliate from the information included in the cookie.

Thus, while a customer using the affiliate's discounts receives a discount or other benefit through a coupon, the affiliate also receives a commission from the retailer. However, many potential customers might not view the coupon discount as enough incentive to use the affiliate-offered services.

### SUMMARY

Features and advantages described in this summary and the following detailed description are not all-inclusive. Many additional features and advantages will be apparent to one of ordinary skill in the art in view of the drawings, specification, and claims hereof. Additionally, other embodiments may omit one or more (or all) of the features and advantages described in this summary.

An affiliate system may provide further incentive to potential customers by offering a rebate or “cash back” for online purchases made using web-based coupons offered by the affiliate. For example, a user may enroll in a rebate program offered by the affiliate. The affiliate may then provide an additional rebate to the enrolled customer when the enrolled customer completes a purchase transaction using an affiliate-offered coupon. In some embodiments, this additional rebate may be some percentage of the purchase transaction commission that the affiliate would receive from the retailer, but that the affiliate shares with the program member. A user of the affiliate system that is not enrolled in the rebate program may also complete an online purchase transaction that would otherwise be eligible for an additional rebate had the user been enrolled. In this scenario, the affiliate system may notify the user that the additional rebate is available and may facilitate any further action by the user to enroll in the rebate program for all eligible future online transactions using the affiliate system.

In one embodiment, a computer-implemented method in a computing device having a processor for managing a rebate service in response to a purchase transaction completed by a client device using a coupon object on a retailer website, the client device operated by a user, may be provided. The method may include determining, by the processor, that the purchase transaction is eligible for a rebate commission, determining, by the processor, that the user is not enrolled in the rebate service, and in response to determining that the user is not enrolled in the rebate service, generating a notification indicating that the purchase transaction is eligible for the rebate commission. The method may further include sending the notification to the client device, the notification selectable by the user to enable the user to enroll in the rebate service, subsequent to sending the notification, determining that the user is enrolled in the rebate service, and crediting an account of the user to reflect the rebate commission.

In another embodiment, a system for managing a rebate service in response to a purchase transaction completed by a client device using a coupon object on a retailer website, the client device operated by a user, is provided. The system may include a network interface, program memory storing instructions, and a processor interfaced with the network interface and the program memory. The processor may be configured to execute the instructions to cause the processor to determine that the purchase transaction is eligible for a rebate commission, determine that the user is not enrolled in the rebate service, and in response to determining at the user is not enrolled in the rebate service, generate a notification indicating that the purchase transaction is eligible for a rebate commission. The processor may be further configured to transmit the notification to the client device via the network interface, the notification selectable by the user to enable the user to enroll in the rebate service, subsequent to transmitting the notification, determine that the user is enrolled in the rebate service, and credit an account of the user to reflect the rebate commission.

### BRIEF DESCRIPTION OF THE DRAWINGS

The figures described below depict various aspects of the system and methods disclosed herein. It should be understood that each figure depicts an embodiment of a particular aspect of the disclosed systems and methods, and that each of the figures is intended to accord with a possible embodiment thereof. Further, wherever possible, the following description refers to the reference numerals included in the following figures, in which features depicted in multiple figures are designated with consistent reference numerals.

FIG. 1 illustrates an exemplary block diagram of a computer network and system on which an exemplary coupon providing system and method may operate to provide notification of a potential rebate for a past or current online purchase transaction and to facilitate a user subscription process;

FIG. 2 illustrates an exemplary flow chart of a method for providing notification of a potential rebate for a past online purchase transaction and facilitating a user subscription process;

FIGS. 3A, 3B, and 3C are block diagrams of data structures used in the system and method to provide notification of a potential rebate for a past or current online purchase transaction and to facilitate a user subscription to a rebate service in accordance with the described embodiments;

FIG. 4 is a block diagram of a computing system that implements a system and method to provide notification of a potential rebate for a past or current online purchase transaction and to facilitate a user subscription to a rebate service in accordance with the described embodiments; and

FIG. 5 illustrates an exemplary flow chart of a method crediting a user with a rebate commission.

### DETAILED DESCRIPTION

The present embodiments may relate to, inter alia, crediting rebate commissions to users who complete purchase transactions via retailer websites. According to certain aspects, an affiliate and an affiliate network may be associated with a retailer that offers products and/or services for sale. Users may operate client devices to access and select one or more coupon objects that may be associated with the products and/or services offered for sale. The affiliate and/or the affiliate network may facilitate the access and selection of the coupon objects, where the affiliate and/or the affiliate network may direct the client devices to access the retailer website in response to the user selecting a certain coupon object. In directing the client devices to the retailer, the affiliate may be eligible for a commission that results from any transactions completed by the users via the retailer website.

According to embodiments, the affiliate may offer a rebate service or program that enables users to receive at least a portion of the commission resulting from completed transactions. The user may enroll in the rebate service at any point, including before or after completing a purchase transaction. In one scenario, after a purchase transaction is completed, the affiliate may determine that the purchase transaction is eligible for a rebate commission and that the user is not enrolled in the rebate service. Accordingly, the affiliate may generate a notification indicating that the user is eligible for the rebate commission, and may transmit the notification to the client device for access by the user. The client device may enable the user to enroll in the rebate service, at which point the affiliate may credit an account of the user to reflect the rebate commission.

The systems and methods therefore offer numerous benefits. In particular, the user is able to register for and receive a rebate commission that the user would have been eligible to receive had the user been enrolled in the rebate service, even in cases in which the user was unaware of the rebate service. Further, an affiliate may be able to effectively attract new and retain existing customers by offering the rebate service. Moreover, the retailer may be also be able to effectively attract new and retain existing customers by participating in the rebate service. It should be appreciated that other benefits are envisioned.

The systems and methods discussed herein therefore address a business challenge, namely ensuring that users are properly credited with rebate commissions to which they may be entitled, that is particular to the Internet. This business challenge arises as a technical problem because rebate commissions are reconciled via the use of data cookies that are transmitted via the Internet for storage on client devices. Although physical coupons have been used in the shopping context for some time, an affiliate that offers digital coupons and a rebate service tracked by data cookies introduces a problem that does not arise in the “brick and mortar” context. Accordingly, the systems and methods are necessarily rooted in computer technology in order to overcome the noted shortcomings that specifically arise in the realm of computer networks.

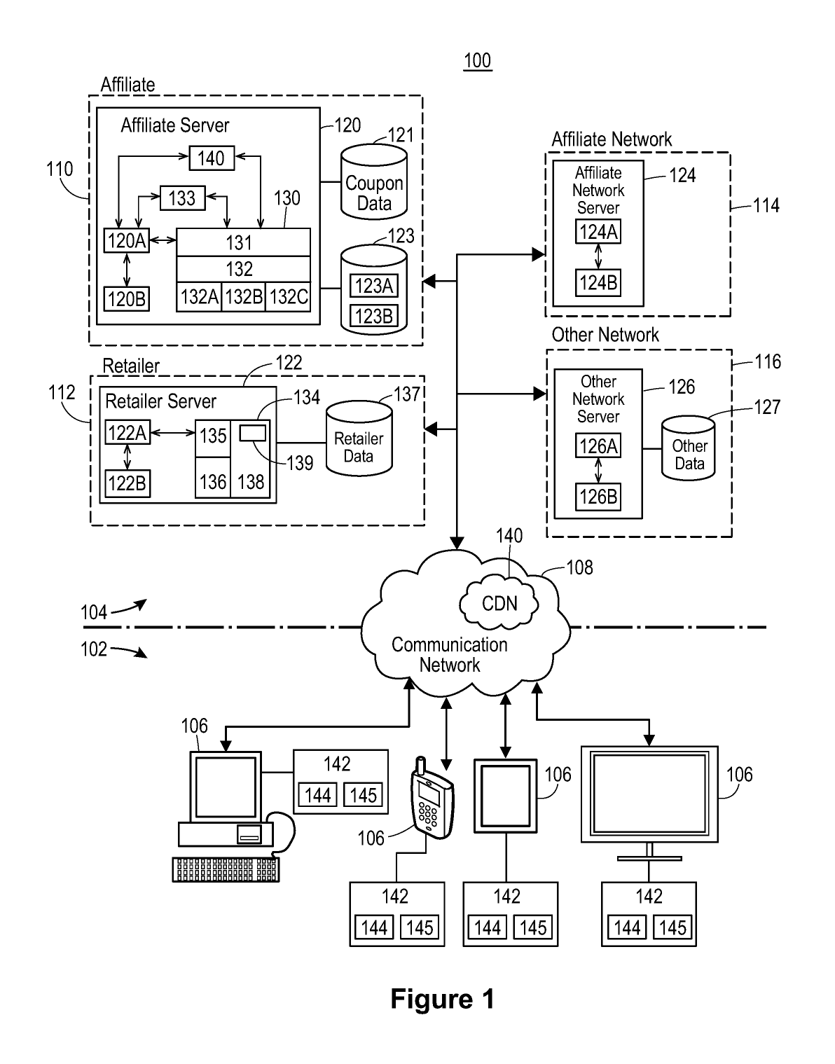

FIG. 1 illustrates various aspects of an exemplary architecture that implements an affiliate or coupon rebate system 100 as a specialized computing system. The high-level architecture includes both hardware and software applications, as well as various data communications channels for communicating data between the various hardware and software components.

The coupon rebate system 100 may be roughly divided into front-end components 102 and back-end components 104. The front-end components 102 are primarily web-enabled devices client computing devices 106 (personal computers, smart phones, tablets, televisions, etc.) connected to a communication network 108 by one or more users. The web-enabled devices 106 may be located, by way of example rather than limitation, in separate geographic locations from each other, including different areas of the same city, different cities, or even different states or countries.

The front-end components 102 communicate with the back-end components 104 via the communication network 108. The communication network 108 may be, for example, a proprietary network, a secure public Internet, a LAN, a virtual private network or some other type of network, such as dedicated access lines, plain ordinary telephone lines, satellite links, combinations of these, etc. If the communication network 108 comprises the Internet, data communication may take place over the network 108 via an Internet communication protocol. The back-end components 104 include a coupon hosting system or affiliate 110 (e.g., a publisher of coupons such as CouponCabin.com, or other Internet-based publicly-accessible system that publishes or hosts coupons), a retailer 112, an affiliate network 114, and other network 116.

The affiliate 110 may include one or more servers 120, each of which includes a memory 120A to store various information, software applications, modules, functions, routines, instructions, etc., and a processor or controller 120B to execute the various applications, modules, functions, routines, instructions, etc. The affiliate 110 further includes a coupon database 121, which is configured to store data such as coupon objects (i.e., computer data representing discount codes, rebates, etc.), discount uniform resource locators (URLs), and other content. The affiliate 110 may access the data stored in the coupon database 121 when executing various functions and tasks associated with the operation of the system 100, as described herein. The affiliate 110 may also include a rebate database 123, which is configured to store data for each user related to a rebate program. For example, the database 123 may include data such as enrollment information for each member of the program, a rebate amount received from a retailer, and other content. The affiliate 110 may store data and access the data stored in the rebate database 123 when executing various functions and tasks associated with the operation of the system 100, as described herein.

Both the retailer 112 and the affiliate network 114 may include one or more servers 122, 124, respectively. Each of the servers 122, 124 includes a memory 122A, 124A to store information, applications, modules, routines, instructions, etc., and a processor or controller 122B, 124B to execute the applications, modules, routines, instructions, etc. The retailer server(s) 122 may be used to facilitate an online purchase transaction, while the affiliate network server(s) 124 may be used to identify the affiliate 110 to the retailer 112.

The other network 116 may host other data such as personal data or user-generated data (e.g., a user's interests, preferences, likes/dislikes, habits, profiles, etc.). The other network 116 may be, for example, a social media network, a blogging network, a customer review site, etc. The other network 116 may include one or more servers 126 connected to one or more other databases 127. Each of the servers 126 includes a memory 126A that stores applications, routines, instructions, etc., and a processor or controller 1268 that executes the applications, routines, instructions, etc. Each of the databases 127 is configured to store the other data, which the network 116 may access when executing various functions and tasks associated with the operation of the system 100, as further described herein.

Although the coupon rebate system 100 is shown to include the affiliate 110 in communication with the retailer 112, the affiliate network 114, the other network 116 and four web-enabled devices 106, it should be understood that different numbers of processing systems, specialized computers, retailers, affiliate networks, other networks, and web-enabled devices may be utilized. For example, the communication network 108 may interconnect the system 100 to a plurality of affiliates 110, retailers 112, affiliate networks 114 and other networks 116, and a vast number of web-enabled devices 106. Generally speaking, the affiliate 110, the retailer 112, the affiliate network 114 and the other network 116 may have various different structures and methods of operation. It should also be understood that while the embodiment shown in FIG. 1 illustrates some of the components and/or data connections that may be present in an exemplary design of an affiliate, a retailer, an affiliate network or other network, the embodiment in FIG. 1 does not illustrate all of the components and/or data connections that may be present and numerous other designs may be utilized.

As shown in FIG. 1, the affiliate 110 may host an affiliate website 130. Coupon data and objects 131, 132 may be retrieved from the coupon database 121 and displayed in the affiliate website 130. In one embodiment, the coupon object 132 may be a clickable object. The clickable object 132 may be any type of static or dynamic object that may be used in an object-oriented computing environment (e.g., the system 100) that may include various data that is used by instructions that are executed by one or more processors of the system. For example, the object 132 may be stored in a memory 120A and include a graphic portion 132A, a plurality of instructions 1328, and a rebate indicator 132C. A user may click on the object 132 as represented by the graphic portion 132A graphically displayed within a display of one or more front end computing devices to cause one or more processors of the system 100 (e.g., processor 1208) to execute the instructions 1328 of the object 132. When executed, the plurality of instructions 1328 may call functions that cause the processor 1208 to perform various calculations, access local or remote data sources, execute local or remote functions, including any of the methods, instructions, function blocks, etc., as herein described. In general, the graphic portion 132A and the plurality of instructions 1328 of the clickable object 132 may include configurable properties that determine how the clickable object 132 is displayed and what function may be called when the user clicks on the object 132.

In some embodiments, the clickable object 132 is a JavaScript browser object (e.g., a button object, an area object, a text object, etc.) stored within the affiliate 110 and include instructions to cause data to be delivered to the web-enabled devices 106 via the communication network 108 in response to a user request. For example, a user attempting to access the affiliate website 130 on one of the devices 106 may open a web browser and enter a URL or other information that requests data from the affiliate 110. The requested data sent to one of the devices 106 may then include a representation of the clickable object 132 and its data (i.e., a graphic object, a coupon code, etc., as described herein).

The rebate indicator 132C may include data that identifies the coupon object 132 as eligible for a rebate as well as various other data to facilitate crediting a registered user with a rebate upon completing a purchase transaction that uses the coupon object 132. For example, the rebate indicator 132C may include the indicator, an amount of the rebate (e.g., a percentage of the commission received by the affiliate from the retailer, a percentage of the purchase price, or any other value associated with the online purchase transaction), and/or alternative rebate data including an amount toward a future purchase with the retailer or related retailers, and other data.

The retailer 112 may similarly host a retailer website 134, which may display retailer data and objects 135, 136 retrieved from a retailer database 137. The database 137 is configured to store data related to various products or items offered by the retailer 112. In some embodiments, the retailer website 134 may include a coupon service object 138. The object 138 may be clickable like the clickable object 132. Like the clickable object 132, activating the clickable coupon service object 138 allows the user to view and select various coupon codes 139 at the retailer website 134 or at another website such as the affiliate website 130.

As generally known in the art, clickable objects (e.g., the clickable objects 132, 138) may include text (some of which may serve as links and URLs to additional information and other websites), buttons, data entry boxes or text fields, pull-down lists, radio buttons, check boxes, and images. Throughout this specification, it is assumed that the clickable objects refer to graphic elements that a user may activate using a mouse or other pointing device. Thus, throughout the specification, the terms “click” and “clicking” may be used interchangeably with the terms “select,” “activate,” or “submit” to indicate the selection or activation of one of the buttons or other display elements. Of course, other methods (e.g., keystrokes, voice commands, etc.) may also be used to select or activate the clickable objects. Moreover, throughout this specification, the terms “link” and “button” are used interchangeably to refer to a graphic representation of a command that may call a method, function, or function block (i.e., the various “block #” as described below) including one or more instructions that are executed by a processor or controller by clicking on the command.

While FIG. 1 only depicts the objects 131, 132, 135, 136 and 138 in the websites 130 and 134, the websites 130 and 134 in general may include any number of objects. Further, while FIG. 1 depicts the websites 130, 134 as separate from the memories 120A, 122A, respectively, the websites 130, 134 may be stored in the memories 120A, 122A, respectively, stored remotely from the affiliate 110 and/or retailer 112, or stored as part of a content delivery network (CDN) 140 located at various points in the communication network 108.

Additionally, various software applications and functions resident in the back-end components 104 provide various user interface methods to allow users (i.e., shoppers and other parties to an online sale transaction, etc.) to access the system 100. One or more of the back-end components 104 may also include various video, image, and graphic design applications to permit the implementation of the websites 130 and 134. In one example implementation, the retailer 112 may design a website (e.g., the retailer website 134) that includes a shopping cart software application, which allows a shopper to complete a checkout process during an online shopping session. The shopping cart application may provide a coupon service (e.g., in the form of a coupon service object such as the object 138), which when activated, allows the shopper to access various coupons from the affiliate 110, the retailer 112, or any other entity during the checkout process.

The affiliate server 120 may also include a “cash back” or rebate module 133 stored in a memory of the system 100 (e.g., the memory 120A). The module 133 includes instructions that are executed by one or more processors (e.g., processor 1208) to implement the method 200 wholly or in part, as described herein (i.e., computer-executable instructions).

The affiliate server 120 may also include a subscriber cookie module 140 stored in a memory of the system 100 (e.g., the memory 120A). The module 133 includes instructions that are executed by one or more processors (e.g., processor 1208) to implement the method 200 wholly or in part, as described herein (i.e., computer-executable instructions).

For example, the computer-executable instructions may cause one or more processors to determine if a coupon object 132 includes a rebate indicator 132C, determine if a client computing device 106 includes a cookie object 144 that indicates the user is subscribed to a rebate program, determine whether a transaction is rebate eligible, determine whether a client computing device includes an affiliate cookie and/or a subscriber cookie (e.g., cookie 144, 145), credit a user's rebate account if the subscriber cookie 144 is present, flag a purchase transaction data record if the cookie is not present, receive commission data at an affiliate, the commission data indicating a commission amount for a completed purchase from a retailer when the purchase is referred through the affiliate, determine whether the user is subscribed to the rebate service, add a rebate amount to a subscribed user's account, notify a user of a potential rebate amount, facilitate a user's subscription to the affiliate rebate program, and determine whether the user has subscribed to the affiliate rebate program using a notification of the potential rebate amount.

For the front-end components 102, each of the web-enabled client computing devices 106 may include a user interface application that may be a web browser 142 (e.g., Microsoft Internet Explorer, Mozilla Firefox, Google Chrome, etc.) for accessing the affiliate 110, the retailer 112, the affiliate network 114, and the other network 116. In general, the browser(s) 142 may be any type of web browsing client, including a proprietary client, and may communicate with the servers 120, 122, 124, 126 using any type of protocol including, but not limited to, file transfer protocol (FTP), telnet, hypertext-transfer protocol (HTTP), etc. In addition, information sent to and from the servers 120, 122, 124, 126 may include data retrieved from the coupon database 121, the retailer database 137, the other databases 127, the CDN 140, and/or the memories 120A, 122A, 124A, 126A.

In some embodiments, each of the browser(s) 142 may also include or have access to one or more mechanisms (e.g., cookies 144, 145) to record transactions for an affiliate to receive credit for directing a customer to a retailer's website to conduct a sale transaction. As such, the servers 120, 122 and 124 may implement any known protocol or method adapted to the purpose of ensuring that the affiliate 110 receives credit for referring the customer to the retailer 112 to complete a sale transaction.

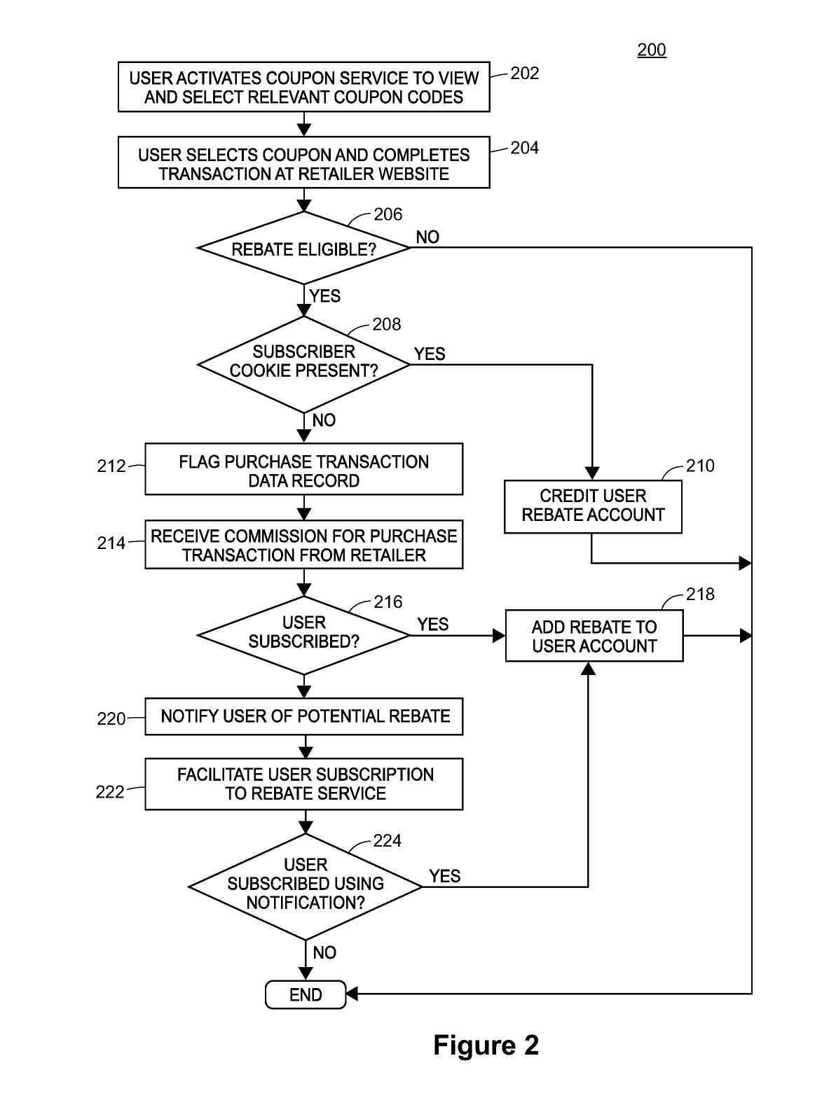

FIG. 2 illustrates one embodiment of a method 200 for identifying online purchase transactions that are eligible for a discount or rebate on the purchase price when the customer is not currently enrolled in the corresponding discount or rebate program, and facilitating enrollment and discount or rebate crediting for the enrolled customer. At block 202, a processor may execute instructions that activate a coupon service to enable a user view and select relevant coupon codes for use during an online purchase transaction. In some embodiments, the user may cause a browser 142 to access one or more of the affiliate 110, the retailer 112, the affiliate network 114, and the other network 116 via the network 108. Using the browser, the user may access the affiliate 110, retailer 112, etc., through one or more websites. Each website may include a plurality of web pages each made up of a plurality of objects (e.g., the objects 135, 136, 138) formatted using a hypertext language such as HTML, XHTML, etc., and may provide navigation to other web pages via hypertext links.

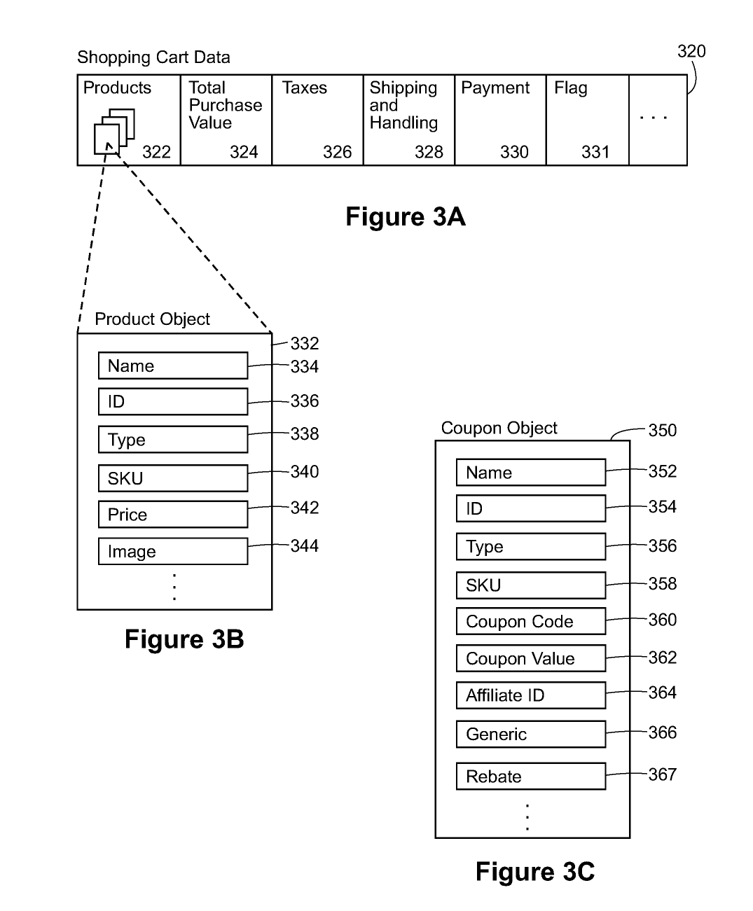

At block 204, the user may select one or more coupon objects (e.g., the coupon object of FIG. 3C) and finish shopping and proceed to complete the checkout process. To this end, the retailer website may include a checkout web page among the plurality of web pages. The checkout web page may include a shopping cart application, which lists the products that the user has chosen to purchase, a price of the products, shipping information, total cost of the transaction, etc.

Any of the web pages described herein may be stored and retrieved from various memory sources (e.g., the memory 122A, the CDN 140, etc.), and served from a server (e.g., the retailer server 122) using HTTP. Web pages may include files of static text, or the server may construct the (X)HTML for a web page when it is requested by the user's browser (i.e., dynamic web pages). The web pages may also provide a coupon service object 138. The coupon service object 138 may be provided by the retailer or another entity different from the retailer (e.g., an affiliate). The coupon service object 138 may be embedded in the HTML of a web page, or the coupon service object 138 may be a linked download specified in the HTML of a web page. Further, the coupon service object 138 may be integrated as an application with an electronic shopping cart of the retailer or other entity described herein.

In some embodiments, the coupon service object 138 is a clickable object provided by an affiliate (e.g., the affiliate 110) which publishes or hosts coupon codes for the retailer. Generally, the coupon service object 138 is in the form of an icon displayed on a web page (e.g., the affiliate web page, the retailer web page, or a combination of web pages), but in other implementations, the coupon service object 138 may be a button, an animated graphic, a text, or any other visual element. The coupon service object 138 may be positioned in a visible area of a web site for easy recognition. Activating the coupon service (i.e., an affiliate website such as CouponCabin.com) allows the user to view and select relevant coupon codes.

In an embodiment, activating the coupon service object 138 allows relevant coupon codes to be used in an online sales transaction. For example, when the user clicks on the coupon service object 138, the retailer 112 may send a request to the affiliate 110 to retrieve the relevant coupon codes from a coupon database (e.g., the coupon database 121). Alternatively or additionally, when the user clicks on the coupon service object 138 at the affiliate website, the affiliate 112 may send a request to the coupon database 121 to retrieve the relevant coupon codes from the coupon database (e.g., the coupon database 121).

After retrieving the relevant coupon codes, the affiliate 110 may transmit the relevant coupon codes back to the user's browser or the retailer 112 to be displayed within a web page. In other embodiments, activating the coupon service object 138 may launch a new website or a new web page. For example, when the user clicks on the coupon service object 138, the user's browser may cause coupon data to be displayed within a browser (e.g., the coupon code or other information), or the user's browser may be redirected to the affiliate website 130 hosted by the affiliate 110.

The user may then view and select the relevant coupon codes shown on the affiliate website 130. Additionally or alternatively, when the user clicks on the coupon service object 138, the affiliate website 130 may be launched and embedded within a web page. In some embodiments, the user may access the affiliate website 130 from within a retailer website. In still other embodiments, the relevant coupon codes may be stored at the retailer 112 or affiliate. In this scenario, when the user clicks on the coupon service object 138, the relevant coupon codes may be retrieved from a retailer database (e.g., the retailer database 137) or affiliate database and displayed within a web page.

Returning to FIG. 2, at block 206, the process 200 may cause a processor to execute an instruction to determine whether the transaction completed at block 204 is rebate eligible. With reference to FIGS. 3A-3D, a processor may execute an instruction to compare data from the retailer server 122 with data from the affiliate server 120. In some embodiments, the method 200 may compare a SKU 340 of a product object 332 with a SKU 358 of a coupon object 350 that includes data 367 indicating that a transaction using the coupon object 350 is eligible for a rebate. If the transaction is not eligible for a rebate, then the method 200 may end.

With reference to FIGS. 3A, 3B, and 3C, data that may be used to determine whether a transaction is rebate eligible includes one or more of shopping cart data 320, product object data 332, and a coupon object 350. Example shopping cart data 320 may include multiple fields that describe various information such as products 322, total purchase value 324, taxes 326, shipping and handling information 328, payment information 330, a rebate flag 331 indicating that the transaction is eligible for a rebate, etc. The products field 322 may further include one or more product objects 332 (FIG. 3B), each representing an individual product or item that the user has chosen to purchase. As such, each product object 332 may include multiple fields that describe the product or item such as a product name 334, a product identification (ID) number 336, a product type 338, a stock keeping unit (SKU) code 340, a price 342, a product image 344, etc.

FIG. 3C illustrates an example coupon object 350. The coupon object 350 may represent a coupon code for a particular product or item. Thus, the product coupon object 350 may include one or more fields such as a product name 352, a product ID 354, a product type 356, a SKU code 358, a coupon code 360, a coupon value 362, an affiliate identification 364, generic data 366, a rebate field 367, etc., that can be used to relate the coupon object 350 to the particular product (i.e., the product object 332). In this manner, certain fields in a product object 332 (e.g., the fields 334-340) may be compared to certain fields in the coupon object 350 (e.g., the fields 352-358) to determine if a relevant coupon code exists for the particular product or item represented by the product object 332. Likewise, certain fields in a product object 332 (e.g., the fields 334-340) may be compared to certain fields in the coupon object 350 (e.g., the fields 352-358) to determine if product is eligible for a rebate 367. For example, the coupon object 350 may represent a coupon code that provides a rebate for the purchase of a product in the shopping cart 320. In this scenario, the coupon object 350 includes the rebate field 367 to signify that a relevant coupon code is available to provide a rebate when the user is subscribed to a rebate program sponsored by the affiliate 110.

At block 208, the process 200 may cause a processor to execute an instruction to determine whether the client computing device 106 executing the browser and completing the purchase transaction includes a subscriber cookie 144. A subscriber cookie 144 is a small piece of data sent from the affiliate 110 to the client device 106 and stored in the client device web browser 142 while the user is browsing a website of the affiliate. Every time the user loads the website, the browser sends the cookie back to the affiliate server 120 to notify the affiliate of the user's previous activity. In some embodiments, the subscriber cookie includes data indicating that the user has subscribed to a rebate service. When the process 200 determines that the subscriber cookie 144 includes data indicating that the user has subscribed to the rebate program, then the process 210 may credit a user rebate account 210 and end. When the process block 208 determines that the subscriber cookie 208 is not present, then process block 212 may cause a processor to execute an instruction to flag a purchase transaction data record (i.e., shopping cart data 320) with a rebate flag 331 indicating that the transaction is eligible for a rebate.

At process block 214, a processor may execute an instruction for the affiliate 110 to receive a commission from the retailer 112 as determined by accessing the rebate indicator 132C associated with the coupon used during the purchase transaction. As described above, the rebate indicator 132C may include data indicating a type of rebate for the purchase transaction that an affiliate 110 receives from the retailer 112.

At process block 216, a processor may execute an instruction to determine whether the user is subscribed to a rebate program of the affiliate. In some scenarios, a user may complete a purchase transaction using a client device that does not include the subscriber cookie 144 due to the cookie being erased or some other circumstance. In some embodiments, the process block 216 may include an instruction to check a rebate database 123 for an indication of whether the user associated with the transaction is enrolled in a rebate program. If the user is enrolled in the rebate program, then at block 218, the process 200 may execute an instruction to add a rebate to the user account. For example, the block 218 may modify data within the rebate database 123 to indicate that a user has been credited with a rebate amount. In some embodiments, the rebate amount may include a percentage of the purchase price, a percentage of the total commission that the affiliate received from the retailer at block 214, or another value.

If process block 216 determines that the user is still not enrolled in the rebate program, the process 200 may execute an instruction to notify the user at process block 220. In some embodiments, process block 220 may cause a processor to send an email, text message, or other notification to the user. The notification may include information indicating an amount of a rebate corresponding to a completed transaction and other information to facilitate a user enrollment in the rebate program.

At process block 222, the process 200 may cause a processor to execute an instruction to facilitate a user subscribing to the rebate service. For example, the notification message of process block 220 may include a web address to redirect the browser 142 to a site where the user may enroll in a rebate program.

At process block 224, the process 200 may cause a processor to execute an instruction to determine whether the user is now subscribed to a rebate program using the notification sent by process block 220. If the user is subscribed, then the process 200 executes process block 218 to add a rebate commission to the user's account. If the user has not subscribed using the notification of block 220, then the process may end.

As described herein, an affiliate system provides further incentive to potential customers by offering a rebate or “cash back” for online purchases made using web-based coupons offered by the affiliate. A user of the affiliate system that is not enrolled in the rebate program may also complete an online purchase transaction that would otherwise be eligible for an additional rebate had the user been enrolled. The affiliate system may then notify the user that the additional rebate is available and may facilitate any further action by the user to enroll in the rebate program for all eligible future online transactions using the affiliate system.

The system and method described herein for providing a notification to a user for a potential rebate to encourage the user to enroll may be well-suited to an affiliate using a commission coupon service. That is, by activating the coupon service and subscribing to the rebate service, one or more cookies may be set on a user's computer that associates one or more affiliates and affiliate networks with the user's online sale transaction. The set cookies allow the one or more affiliates and affiliate networks to be identified in order to receive a commission credit for the sale and, thus, share the commission with subscribers to the rebate service.

To illustrate this concept, an example affiliate referral or identification process is described herein. With reference to the Figures, the affiliate referral or identification process may begin after a user activates or selects a coupon service object 138 during a checkout process at a retailer 112 or upon visiting a web site of the affiliate that displays the clickable objects associated with the coupon objects. The coupon service object 138 may be provided by an affiliate 110 (e.g., at the affiliate web site, included in a checkout web page of a retailer website 134 associated with the retailer 112, etc.). Upon activation by the user, the coupon service object 138 may launch a request to an affiliate network 114 via an embedded URL so that the affiliate network 114 can identify the affiliate 110 to the retailer 112. This in turn also identifies the affiliate network 114 to the retailer 112. To identify the affiliate 110, the coupon service object 138 may include an identifying code or other information in the embedded URL.

Using the identifying code, the affiliate network 114 may set a value for an affiliate's cookie 144 on the user's web-enabled device 106. Similarly, the affiliate network 114 may also set a value for an affiliate network's cookie 145 on the user's web-enabled device 106. The cookies 144 and 145 act to identify the affiliate 110 and the affiliate network 114 to the retailer 112. In some implementations, the identifying code is used to generate the value for the affiliate network's cookie 145. Thus, the value for the affiliate's cookie 144 and the value for the affiliate network's cookie 145 may be different values. In other implementations, the identifying code is used as the value for the affiliate network's cookie 145. Thus, the value for the affiliate's cookie 144 and the value for the affiliate network's cookie 145 may be identical.

Back at the retailer website 134, a retailer server 122 of the retailer 112 may read one or both of the cookies 144 and 145 on the user's web-enabled device 106. If the retailer server 122 discovers the set affiliate's cookie 144, then the retailer server 122 associates an indication of the affiliate 110 with a record of any sale transaction that results at the retailer website 134. The affiliate 110 is then credited with the sale. If the retailer server 122 discovers the set affiliate network's cookie 145, then the retailer server 122 associates an indication of the affiliate network 114 with a record of any sale transaction that results at the retailer website 134. This ensures that the affiliate network 114 is able to subsequently credit the affiliate 110 with the sale and, in turn, the affiliate is able to credit the purchaser/user who is subscribed to the rebate program with a rebate amount. The indication of the association between the transaction record and the affiliate 110 and/or the affiliate network 114 may be stored within a memory 122A of the retailer 122, for example.

From the stored indication and transaction record, the affiliate 110 and the affiliate network 114 may receive a sales commission according to terms of any agreement between the affiliate 110, the affiliate network 114, and the retailer 112. Once the user completes the sale transaction, the retailer server 122 logs the sale back to the affiliate network 114 and the affiliate network 114 may report the completed sale back to the affiliate 110. When the sale transaction has been reported to the affiliate 110, the affiliate 110, the affiliate network 114, and the user who is subscribed to the rebate program may earn a percentage commission on the completed sale.

On the other hand, if the cookies 144 and 145 are not set, then the retailer 112 cannot determine if the affiliate 110 or the affiliate network 114 facilitated in the transaction. As such, no credit is awarded to either party.

This detailed description is to be construed as exemplary only and does not describe every possible embodiment, as describing every possible embodiment would be impractical, if not impossible. One could implement numerous alternate embodiments, using either current technology or technology developed after the filing date of this patent application.

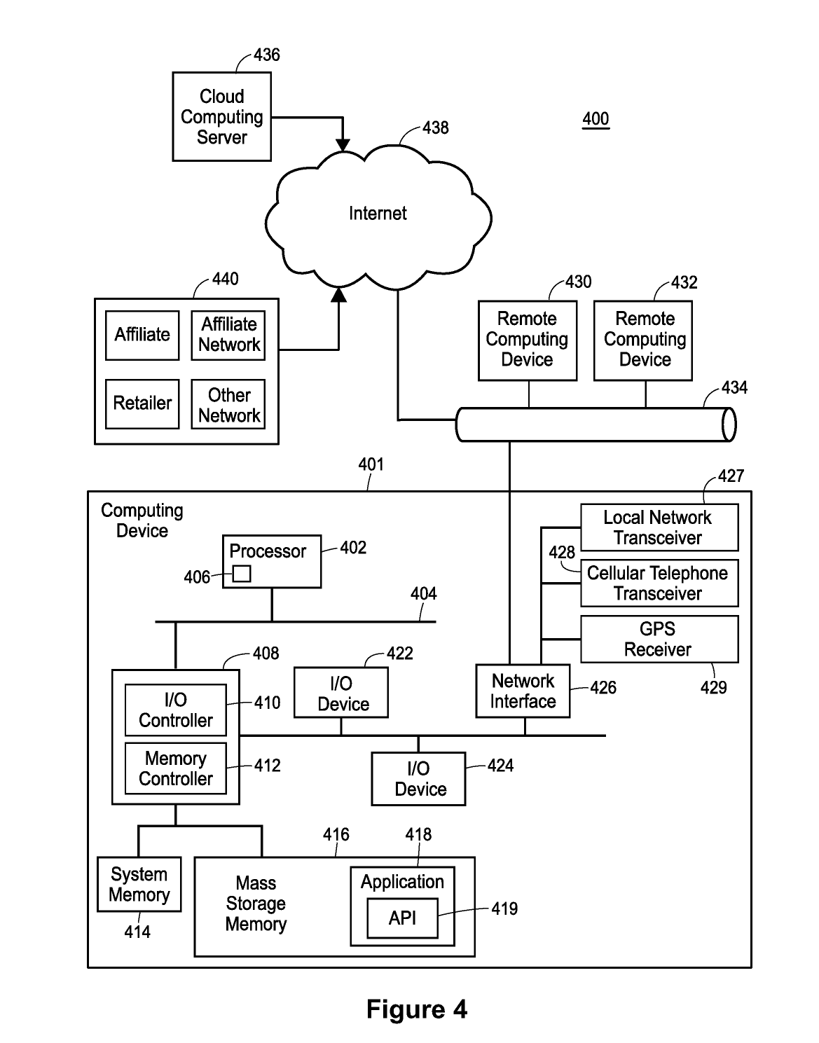

FIG. 4 is a block diagram of an example specialized computing system 400 for implementing a system and method for identifying online purchase transactions that are eligible for a discount or rebate on the purchase price when the customer is not currently enrolled in the corresponding discount or rebate program, and facilitating enrollment and discount or rebate crediting for the enrolled customer. In some embodiments, system 400 may include computer-executable instructions (e.g., the methods described herein) stored within one or more memories and executed using a processor to create a specialized computing device. The computing system 400 may have a specialized computing device 401 that may be used to implement the systems and methods described herein. The computing device 401 may include an affiliate 110, a retailer 112, an affiliate network 114, other network 116, and one or more web-enabled computing devices 106 (e.g., a cellular phone, a tablet computer, a thin client, a Wi-Fi-enabled device or other personal computing device capable of wireless or wired communication.

As will be recognized by one skilled in the art, in light of the disclosure and teachings herein, other types of computing devices can be used that have different architectures. Processor systems similar or identical to the system 400 may be used to implement and execute the example system of FIG. 1, method of FIG. 2, the data structures of FIGS. 3A-3C and the like. Although the system 400 is described below as including a plurality of peripherals, interfaces, chips, memories, etc., one or more of those elements may be omitted from other example processor systems used to implement and execute the example coupon rebate system 100. Also, other components may be added.

As shown in FIG. 4, the computing device 401 includes a processor 402 that is coupled to an interconnection bus 404. The processor 402 includes a register set or register space 406, which is depicted in FIG. 4 as being entirely on-chip, but which could alternatively be located entirely or partially off-chip and directly coupled to the processor 402 via dedicated electrical connections and/or via the interconnection bus 404. The processor 402 may be any suitable processor, processing unit or microprocessor. Although not shown in FIG. 4, the computing device 401 may be a multi-processor device and, thus, may include one or more additional processors that are identical or similar to the processor 402 and that are communicatively coupled to the interconnection bus 404.

The processor 402 of FIG. 4 is coupled to a chipset 408, which includes a memory controller 410 and a peripheral input/output (I/O) controller 412. As is well known, a chipset typically provides I/O and memory management functions as well as a plurality of general purpose and/or special purpose registers, timers, etc. that are accessible or used by one or more processors coupled to the chipset 408. The memory controller 410 performs functions that enable the processor 402 (or processors if there are multiple processors) to access a system memory 414 and a mass storage memory 416, that may include either or both of an in-memory cache (e.g., a cache within the memory 414) or an on-disk cache (e.g., a cache within the mass storage memory 416).

The system memory 414 may include any desired type of volatile and/or non-volatile memory such as, for example, static random access memory (SRAM), dynamic random access memory (DRAM), flash memory, read-only memory (ROM), etc. The mass storage memory 416 may include any desired type of mass storage device. For example, if the computing device 401 is used to implement an application 418 having an API 419 (including functions and instructions as described by the method 200 of FIG. 2). The mass storage memory 416 may include a hard disk drive, an optical drive, a tape storage device, a solid-state memory (e.g., a flash memory, a RAM memory, etc.), a magnetic memory (e.g., a hard drive), or any other memory suitable for mass storage.

As used herein, the terms module, block, function, operation, procedure, routine, step, and method refer to tangible, non-transitory computer program logic or tangible and non-transitory computer executable instructions that provide the specified functionality to the computing device 401 and the computing system 400. Thus, a module, block, function, operation, procedure, routine, step, and method can be implemented in hardware, firmware, and/or software. In one embodiment, program modules and routines (e.g., the application 418, the API 419, etc.) are stored in mass storage memory 416, loaded into system memory 414, and executed by a processor 402 or can be provided from computer program products that are stored in tangible computer-readable storage mediums (e.g., RAM, hard disk, optical/magnetic media, etc.).

The peripheral I/O controller 410 performs functions that enable the processor 402 to communicate with peripheral input/output (I/O) devices 422 and 424, a network interface 426, a local network receiver 427, a cellular telephone transceiver 428, and a GPS transceiver 429 via the network interface 426. The I/O devices 422 and 424 may be any desired type of I/O device such as, for example, a keyboard, a display (e.g., a liquid crystal display (LCD), a cathode ray tube (CRT) display, etc.), a navigation device (e.g., a mouse, a trackball, a capacitive touch pad, a joystick, etc.), etc.

The cellular telephone transceiver 428 may be resident with the local network transceiver 427, for example. The local network transceiver 427 may include support for a Wi-Fi network, Bluetooth, Infrared, or other wireless data transmission protocols. In other embodiments, one element may simultaneously support each of the various wireless protocols employed by the computing device 401. For example, a software-defined radio may be able to support multiple protocols via downloadable instructions. In operation, the computing device 401 may be able to periodically poll for visible wireless network transmitters (both cellular and local network) on a periodic basis. Such polling may be possible even while normal wireless traffic is being supported on the computing device 401. The network interface 426 may be, for example, an Ethernet device, an asynchronous transfer mode (ATM) device, an 802.11 wireless interface device, a DSL modem, a cable modem, a cellular modem, etc., that enables the system 100 to communicate with another computer system having at least the elements described in relation to the system 100.

While the memory controller 412 and the I/O controller 410 are depicted in FIG. 4 as separate functional blocks within the chipset 408, the functions performed by these blocks may be integrated within a single integrated circuit or may be implemented using two or more separate integrated circuits. The computing system 400 may also implement the application 418 on remote computing devices 430 and 432. The remote computing devices 430 and 432 may communicate with the computing device 401 over an Ethernet link 434. For example, the computing device 401 may receive data created by an application executing on a remote computing device 430, 432. In some embodiments, the application 418 may be retrieved by the computing device 401 from a cloud computing server 436 via the Internet 438.

When using the cloud computing server 436, the retrieved application 418 may be programmatically linked with the computing device 401. The application 418 may be a Java® applet executing within a Java® Virtual Machine (JVM) environment resident in the computing device 401 or the remote computing devices 430, 432. The application 418 may also be “plug-ins” adapted to execute in a web-browser located on the computing devices 401, 430, and 432. In some embodiments, the application 418 may communicate with backend components 440 such as the affiliate 110, the retailer 112, the affiliate network 114 and the other network 116 via the Internet 438.

The computing system 400 may include but is not limited to any combination of a LAN, a MAN, a WAN, a mobile, a wired or wireless network, a private network, or a virtual private network. Moreover, while only two remote computing devices 430 and 432 are illustrated in FIG. 4 to simplify and clarify the description, it is understood that any number of client computers are supported and can be in communication within the system 400.

As discussed herein, the system may rely on the presence of a subscriber cookie that is stored on a client device to properly credit any rebate to the user. During a transaction that is eligible for a rebate, a browser of the client device may send a copy of the subscriber cookie to the server 120 of the affiliate 110. At the conclusion of the transaction, the server 120 may then use the received subscriber cookie to credit an account of the user to reflect a rebate commission. However, if the client device does not include or store the subscriber cookie at the time of the transaction (e.g., the user has deleted cookies or is otherwise using a device that does not include the subscriber cookie), then the user will not receive proper credit for the rebate-eligible transaction.

In prior systems, the user could manually initiate a complaint, such as via a web interface, and the affiliate could credit the account of the user while an employee of the affiliate could review and either accept or deny the credit amount. According to the present embodiments, the affiliate 110 may automate this process to eliminate manual employee review of each missing credit request.

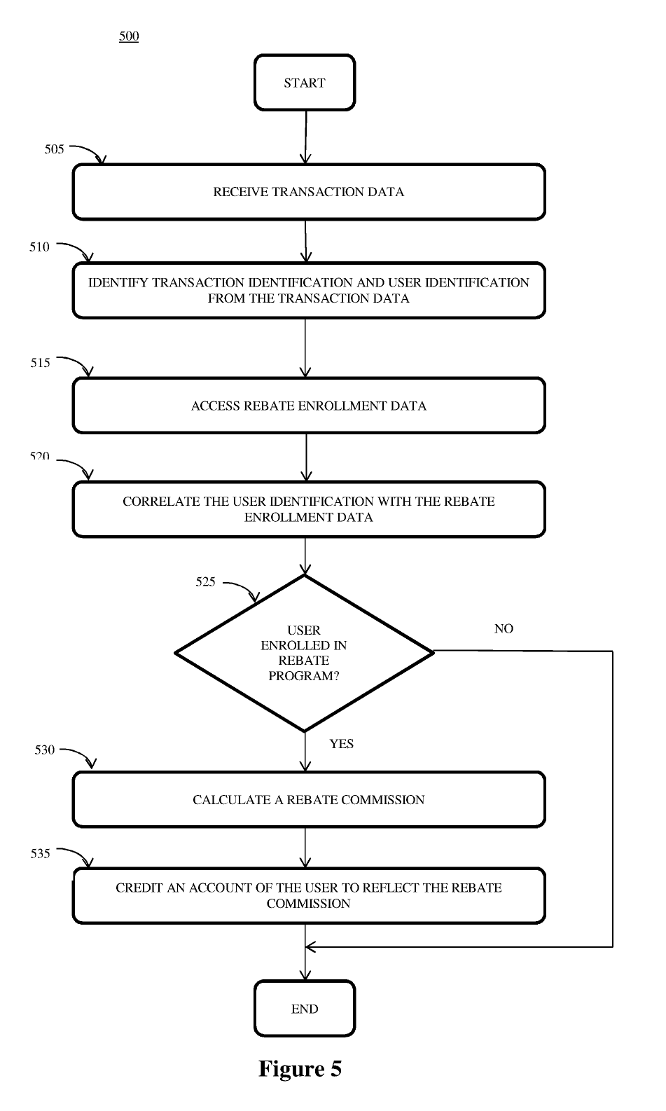

FIG. 5 is a flow chart of a method 500 for crediting a user with a rebate commission in the event that a client device of the user does not store an appropriate subscriber cookie. The method 500 may be performed by a processor or module of a server, such as the computing device 401 as discussed with respect to FIG. 4. Prior to the processor initiating the method 500, a user may use the client device to complete a purchase transaction on a website of a retailer, where the purchase transaction may generate transaction data. The retailer may forward the transaction data to an affiliate, for example using data included in a cookie that is retrieved from the client device (e.g., a data cookie other than a subscriber cookie).

Accordingly, the processor of the server may receive (block 505) the transaction data. In some implementations, the processor may receive the transaction data from the retailer via an affiliate network. The processor may identify (block 510) a transaction identification and a user identification from the transaction data. In embodiments, the transaction identification may uniquely identify the purchase transaction and the user identification may uniquely identify the user.

The processor may access (block 515) rebate enrollment data, which may include data identifying a set of users who are enrolled in a rebate service or program (e.g., a set of e-mail addresses). The processor may correlate (block 520) the user identification included in the transaction data with the rebate enrollment data. In particular, the processor may determine whether the user identification is included or referenced in the rebate enrollment data.

Based on the correlation of block 520, the processor may determine (block 525) whether the user is enrolled in the rebate program (i.e., whether the user identification is included or referenced in the rebate enrollment data). If the processor determines that the user is not enrolled in the rebate program (“NO”), processing may end or proceed to other functionality. If the processor determines that the user is enrolled in the rebate program (“YES”), the processor may calculate (block 530) a rebate commission to which the user is entitled. According to embodiments, the rebate commission may be at least a portion of a commission to which the affiliate is entitled for directing the user to the retailer website, such as a portion of the amount of the purchase transaction. The processor may credit (block 535) an account of the user to reflect the rebate commission. In embodiments, the processor may also notify the user that the rebate commission has been credited to the account.

Additionally, certain embodiments are described herein as including logic or a number of components, modules, or mechanisms. Modules may constitute either software modules (e.g., code or instructions embodied on a machine-readable medium or in a transmission signal, wherein the code is executed by a processor) or hardware modules. A hardware module is tangible unit capable of performing certain operations and may be configured or arranged in a certain manner. In example embodiments, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various embodiments, a hardware module may be implemented mechanically or electronically. For example, a hardware module may comprise dedicated circuitry or logic that is permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that is temporarily configured by software to perform certain operations in a specialized manner. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. As used herein, “hardware-implemented module” refers to a hardware module. Considering embodiments in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules can provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In embodiments in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it is communicatively coupled. A further hardware module may then, at a later time, access the memory device to retrieve and process the stored output. Hardware modules may also initiate communications with input or output devices, and can operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example embodiments, comprise processor-implemented modules.

Similarly, the methods or routines described herein may be at least partially processor-implemented. For example, at least some of the operations of a method may be performed by one or processors or processor-implemented hardware modules. The performance of certain of the operations may be distributed among the one or more processors, not only residing within a single machine, but deployed across a number of machines. In some example embodiments, the processor or processors may be located in a single location (e.g., within a home environment, an office environment or as a server farm), while in other embodiments the processors may be distributed across a number of locations.

The one or more processors may also operate to support performance of the relevant operations in a “cloud computing” environment or as a “software as a service” (SaaS). For example, at least some of the operations may be performed by a group of computers (as examples of machines including processors), these operations being accessible via a network (e.g., the Internet) and via one or more appropriate interfaces (e.g., application program interfaces (APIs)).

The performance of certain of the operations may be distributed among the one or more processors, not only residing within a single machine, but deployed across a number of machines. In some example embodiments, the one or more processors or processor-implemented modules may be located in a single geographic location (e.g., within a home environment, an office environment, or a server farm). In other example embodiments, the one or more processors or processor-implemented modules may be distributed across a number of geographic locations.

Some portions of this specification are presented in terms of algorithms or symbolic representations of operations on data stored as bits or binary digital signals within a machine memory (e.g., a computer memory). These algorithms or symbolic representations are examples of techniques used by those of ordinary skill in the data processing arts to convey the substance of their work to others skilled in the art. As used herein, an “algorithm” is a self-consistent sequence of operations or similar processing leading to a desired result. In this context, algorithms and operations involve physical manipulation of physical quantities. Typically, but not necessarily, such quantities may take the form of electrical, magnetic, or optical signals capable of being stored, accessed, transferred, combined, compared, or otherwise manipulated by a machine. It is convenient at times, principally for reasons of common usage, to refer to such signals using words such as “data,” “content,” “bits,” “values,” “elements,” “symbols,” “characters,” “terms,” “numbers,” “numerals,” or the like. These words, however, are merely convenient labels and are to be associated with appropriate physical quantities.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “some embodiments” or “an embodiment” means that a particular element, feature, structure, or characteristic described in connection with the embodiment is included in at least one embodiment. The appearances of the phrase “in some embodiments” in various places in the specification are not necessarily all referring to the same embodiment.

Some embodiments may be described using the expression “coupled” and “connected” along with their derivatives. For example, some embodiments may be described using the term “coupled” to indicate that two or more elements are in direct physical or electrical contact. The term “coupled,” however, may also mean that two or more elements are not in direct contact with each other, but yet still co-operate or interact with each other. The embodiments are not limited in this context.

Further, the figures depict preferred embodiments of a system and method for identifying online purchase transactions that are eligible for a discount or rebate on the purchase price when the customer is not currently enrolled in the corresponding discount or rebate program, and facilitating enrollment and discount or rebate crediting for the enrolled customer. One skilled in the art will readily recognize from the following discussion that alternative embodiments of the structures and methods illustrated herein may be employed without departing from the principles described herein.

Upon reading this disclosure, those of skill in the art will appreciate still additional alternative structural and functional designs for a system and a process for providing a system and method for identifying online purchase transactions that are eligible for a discount or rebate on the purchase price when the customer is not currently enrolled in the corresponding discount or rebate program, and facilitating enrollment and discount or rebate crediting for the enrolled customer through the disclosed principles herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein.

What is claimed is:

1. A computer-implemented method in a computing device having a processor for managing a rebate service in response to a purchase transaction completed by a client device using a coupon object on a retailer website, the client device operated by a user, the method comprising:
determining, by the processor, that the purchase transaction is eligible for a rebate commission;
determining, by the processor, that the user is not enrolled in the rebate service;
in response to determining that the user is not enrolled in the rebate service, generating a notification indicating that the purchase transaction is eligible for the rebate commission;
sending the notification to the client device, the notification selectable by the user to enable the user to enroll in the rebate service;
subsequent to sending the notification, determining that the user is enrolled in the rebate service; and
crediting an account of the user to reflect the rebate commission.

2. The computer-implemented method of claim 1, wherein determining that the user is not enrolled in the rebate service comprises:
determining that a subscriber cookie is not present on the client device; and
flagging the purchase transaction to indicate that the purchase transaction is eligible for the rebate commission.

3. The computer-implemented method of claim 1, wherein determining that the user is not enrolled in the rebate service comprises:
identifying a subscriber cookie stored on the client device; and
determining, from the subscriber cookie, that the user is not enrolled in the rebate service.

4. The computer-implemented method of claim 1, wherein determining that the user is not enrolled in the rebate service comprises:
examining a rebate database to determine that the user is not enrolled in the rebate service.

5. The computer-implemented method of claim 1, further comprising:
sending a subscriber cookie to the client device for storage on the client device.

6. The computer-implemented method of claim 1, wherein determining that the purchase transaction is eligible for the rebate commission comprises:
comparing an identification of a product included in the purchase transaction to an identification of the coupon object for the product; and
determining that the purchase transaction using the coupon object is eligible for the rebate commission.

7. The computer-implemented method of claim 1, wherein determining that the purchase transaction is eligible for the rebate commission comprises:
identifying, in shopping cart data associated with the purchase transaction, a rebate flag indicating that the purchase transaction is eligible for the rebate commission.

8. The computer-implemented method of claim 1, wherein sending the notification to the client device comprises:
sending a web address to the client device, wherein selection of the web address causes a browser of the client device to access a website that enables the user to enroll in the rebate service.

9. The computer-implemented method of claim 1, further comprising:
causing (i) an affiliate cookie, and (ii) an affiliate network cookie to be stored on the client device, wherein the retailer website reads the affiliate cookie and the affiliate network cookie on the client device to enable the account of the user to be credited to reflect the rebate commission.

10. The computer-implemented method of claim 1, wherein crediting the account of the user to reflect the rebate commission comprises:
examining a rebate indicator associated with the coupon object used in the purchase transaction, the rebate indicator indicating the rebate commission.

11. A system for managing a rebate service in response to a purchase transaction completed by a client device using a coupon object on a retailer website, the client device operated by a user, the system comprising:
a network interface;
program memory storing instructions; and
a processor interfaced with the network interface and the program memory, and configured to execute the instructions to cause the processor to:
determine that the purchase transaction is eligible for a rebate commission,
determine that the user is not enrolled in the rebate service,
in response to determining at the user is not enrolled in the rebate service, generate a notification indicating that the purchase transaction is eligible for a rebate commission,
transmit the notification to the client device via the network interface, the notification selectable by the user to enable the user to enroll in the rebate service,
subsequent to transmitting the notification, determine that the user is enrolled in the rebate service, and
credit an account of the user to reflect the rebate commission.

12. The system of claim 11, wherein to determine that the user is not enrolled in the rebate service, the processor is configured to:
determine that a subscriber cookie is not present on the client device, and
flag the purchase transaction to indicate that the purchase transaction is eligible for the rebate commission.

13. The system of claim 11, wherein to determine that the user is not enrolled in the rebate service, the processor is configured to:
identify a subscriber cookie stored on the client device, and
determine, from the subscriber cookie, that the user is not enrolled in the rebate service.

14. The system of claim 11, wherein to determine that the user is not enrolled in the rebate service, the processor is configured to:
examine a rebate database to determine that the user is not enrolled in the rebate service.

15. The system of claim 11, wherein the processor is further configured to:
send, via the network interface, a subscriber cookie to the client device for storage on the client device.

16. The system of claim 11, wherein to determine that the purchase transaction is eligible for the rebate commission, the processor is configured to:
compare an identification of a product included in the purchase transaction to an identification of the coupon object for the product, and
determine that the purchase transaction using the coupon object is eligible for the rebate commission.

17. The system of claim 11, wherein to determine that the purchase transaction is eligible for the rebate commission, the processor is configured to:
identify, in shopping cart data associated with the purchase transaction, a rebate flag indicating that the purchase transaction is eligible for the rebate commission.

18. The system of claim 11, wherein to send the notification to the client device, the processor is configured to:
send a web address to the client device, wherein selection of the web address causes a browser of the client device to access a website that enables the user to enroll in the rebate service.

19. The system of claim 11, wherein the processor is further configured to:
cause (i) an affiliate cookie, and (ii) an affiliate network cookie to be stored on the client device, wherein the retailer website reads the affiliate cookie and the affiliate network cookie on the client device to enable the account of the user to be credited to reflect the rebate commission.

20. The system of claim 11, wherein to credit the account of the user to reflect the rebate commission, the processor is configured to:
examine a rebate indicator associated with the coupon object used in the purchase transaction, the rebate indicator indicating the rebate commission.
